(19) United States
(12) Patent Application Publication
(10) Pub. No.: US 2005/0185308 A1
(43) Pub. Date: Aug. 25, 2005

(54) Lateral-view mirror assembly for a vehicle

(76) Inventor: Lowell Martinson, Phoenix, AZ (US)

Correspondence Address: WEISS & MOY PC, 4204 NORTH BROWN AVENUE, SCOTTSDALE, AZ, 85251, US

(21) Appl. No.: 11/081,425

(22) Filed: Mar. 16, 2005

Related U.S. Application Data
(63) Continuation-in-part of application No. 09/875,212, filed on Jun. 7, 2001, now abandoned.

(51) Int. Cl. G02B 5/08; G02B 7/18; G02B 7/182

(52) U.S. Cl. 359/855; 359/871

(57) ABSTRACT

A lateral-view mirror assembly having at least one indicator light integrated with a vehicle indicator light system and capable of providing a driver of a vehicle with the ability to view objects positioned lateral to a rear portion of the vehicle by looking at a reflection of the objects reflected from the lateral-view mirror to the driver while at the same time indicating to others a braking and/or turning signal.

### CROSS-REFERENCE TO RELATED APPLICATIONS

This is a continuation-in-part of U.S. patent application Ser. No. 09/875,212 filed Jun. 7, 2001 in the name of the Applicant, to which priority is claimed.

### FIELD OF THE INVENTION

This invention relates generally to mirrors for vehicles designed to aid a driver in identifying objects and, more specifically, to a lateral-view mirror assembly for a vehicle dimensioned to allow a driver to view objects positioned lateral to a rear portion of the vehicle while at the same time an exterior surface of the mirror housing comprises at least one indicator light integrated with the vehicle indicator light system of a vehicle in order to alert other drivers and pedestrians of braking and/or turning.

### BACKGROUND OF THE INVENTION

Driving a car or other vehicle safely requires the driver to constantly be able to see other vehicles, objects and pedestrians. This is often difficult since a car has many blind-spots, and the driver generally is facing forward with limited ability to turn around and view surrounding areas. One situation where a driver's limited field of vision presents an especially acute problem is when pulling out of a parking spot. When a driver needs to back out of a parking space in which he or she is parked face-forward between two other vehicles, especially when those vehicles are large in size, the driver has no ability to see laterally to either side of the rear portion of his or her vehicle to determine if there are pedestrians or other vehicles about to cross into his or her path. Often, most drivers in this situation simply back out slowly in an attempt to alert pedestrians and other cars of the vehicle's presence. This method is fraught with danger. It is often the case that pedestrians walking through a parking lot simply do not see a car as it backs out. The same is the case for another vehicle or a bike which might be passing quickly behind the driver's vehicle as he backs out. In all of these cases, it is the parked vehicle's driver who is responsible for ensuring that his or her car does not strike a pedestrian or vehicle. In order to be sure that a pedestrian or vehicle is not approaching, the driver must be able to see laterally from a rear portion of the driver's vehicle.

Several attempts have been made to address this problem. While various inventions are directed to lateral-view mirrors, none of these mirrors comprise an indicator light that is integrated with a vehicle indicator light system in order to allow the driver to not only see objects lateral to a rear portion of their vehicle but also indicate to other drivers and pedestrians that they are braking or turning.

Thus, a need existed for a lateral-view mirror assembly for a vehicle dimensioned to allow a driver to view people, vehicles and other objects positioned lateral to a rear portion of the vehicle by looking at a reflection of those objects through a lateral-view mirror while at the same time allowing the driver to indicate to other drivers and pedestrians a braking and/or turning signal.

### SUMMARY OF THE INVENTION

An object of the present invention is to provide a lateral-view mirror assembly for a vehicle having an indicator light integrated with a vehicle indicator light system and capable of allowing a driver to view objects positioned lateral to a rear portion of the vehicle while at the same time indicating to others a braking and/or turning signal.

It is a further object of the present invention to provide a lateral-view mirror assembly for a vehicle capable of housing an antenna dimensioned to receive at least one data signal and transmit this signal to an electronic device coupled to the vehicle.

It is still a further object of the present invention to provide a method for indicating driver behavior providing a lateral-view mirror assembly for a vehicle having an indicator light that is integrated with a vehicle indicator light system and capable of allowing a driver to view objects positioned lateral to a rear portion of the vehicle while at the same time indicating to others a braking and/or turning signal.

### BRIEF DESCRIPTION OF THE PREFERRED EMBODIMENTS

In accordance with one embodiment of the present invention, a lateral-view mirror assembly for a vehicle is disclosed, comprising, in combination, at least one housing dimensioned to be coupled to at least one of a driver's side rear side portion of a vehicle and a passenger's side rear side portion of a vehicle, at least one lateral-view mirror, each of the at least one lateral-view mirror coupled to the at least one housing, the lateral-view mirror dimensioned to allow a driver to view objects positioned lateral to one of the driver's side of a rear portion of the vehicle and the passenger's side of a rear portion of the vehicle by looking at a reflection of the objects reflected from the lateral-view mirror to a vehicle side-view mirror to the driver, and at least one indicator light coupled to an exterior surface of the at least one housing, the at least one indicator light integrated with a vehicle indicator light system in order to allow the indicator light to indicate at least one of a braking signal and a turning signal.

In accordance with another embodiment of the present invention, a lateral-view mirror assembly for a vehicle is disclosed, comprising, in combination, a housing coupled to a substantially center portion of a top surface of a rear portion of a vehicle, a first lateral-view mirror coupled to the housing, the first lateral-view mirror being positioned in a line of sight with a rear-view mirror of a vehicle, the first lateral-view mirror being dimensioned to allow a driver to view objects positioned lateral to a driver's side of a rear portion of a vehicle by looking at a reflection of objects reflected from the first lateral-view mirror to a rear-view mirror to a driver, a second lateral-view mirror coupled to the housing, the second lateral-view mirror being positioned in a line of sight with a rear-view mirror of a vehicle, the second lateral-view mirror being dimensioned to allow a driver to view objects positioned lateral to a passenger's side of a rear portion of a vehicle by looking at a reflection of objects reflected from the second lateral-view mirror to a rear-view mirror to a driver, at least one indicator light coupled to an exterior surface of the housing, the at least one indicator light integrated with a vehicle indicator light system in order to allow the indicator light to indicate at least one of a braking signal and a turning signal.

In accordance with yet another embodiment of the present invention, a lateral-view mirror assembly for a vehicle is disclosed, comprising, in combination, a first housing dimensioned to be coupled to a top surface of a rear portion of a vehicle, a first lateral-view mirror coupled to the first housing, the first lateral-view mirror being positioned in a line of sight with a rear-view mirror of a vehicle, the first lateral-view mirror being dimensioned to allow a driver to view objects positioned lateral to a passenger's side of a rear portion of a vehicle by looking at a reflection of objects reflected from the first lateral-view mirror to a rear-view mirror to a driver, at least one indicator light coupled to an exterior surface of the first housing, the at least one indicator light integrated with a vehicle indicator light system in order to allow the indicator light to indicate at least one of a braking signal and a turning signal, a second housing dimensioned to be coupled to a top surface of a rear portion of a vehicle, a second lateral-view mirror coupled to the second housing, the second lateral-view mirror being positioned in a line of sight with a rear-view mirror of a vehicle, the second lateral-view mirror being dimensioned to allow a driver to view objects positioned lateral to a driver's side of a rear portion of a vehicle by looking at a reflection of objects reflected from the first lateral-view mirror to a rear-view mirror to a driver, and at least one indicator light coupled to an exterior surface of the second housing, the at least one indicator light integrated with a vehicle indicator light system in order to allow the indicator light to indicate at least one of a braking signal and a turning signal.

In accordance with still another embodiment of the present invention, a lateral-view mirror assembly for a vehicle is disclosed, comprising, in combination, a spoiler having a top surface and a bottom surface and coupled to a top area of a rear portion of a vehicle, a first housing dimensioned to be attached to the spoiler proximate a passenger's side portion of the vehicle, a first lateral-view mirror coupled to the first housing, the first lateral-view mirror being positioned in a line of sight with a rear view mirror of the vehicle, the first lateral-view mirror being dimensioned to allow a driver to view objects positioned lateral to a passenger's side of a rear portion of the vehicle by looking at a reflection of the objects reflected from the first lateral view mirror to the rear-view mirror to the driver, at least one indicator light coupled to an exterior surface of the first housing, the at least one indicator light integrated with a vehicle indicator light system in order to allow the indicator light to indicate at least one of a braking signal and a turning signal, a second housing dimensioned to be attached to the spoiler proximate a driver's side portion of the vehicle, a second lateral-view mirror coupled to the second housing, the second lateral-view mirror being positioned in a line of sight with a rear-view mirror, the second lateral-view mirror being dimensioned to allow a driver to view objects positioned lateral to a driver's side of a rear portion of the vehicle by looking at a reflection of the objects reflected from the second lateral-view mirror to the rear-view mirror to the driver, and at least one indicator light coupled to an exterior surface of the second housing and facing towards a rear portion of the vehicle, the at least one indicator light integrated with a vehicle indicator light system in order to allow the indicator light to indicate at least one of a braking signal and a turning signal.

In accordance with still another embodiment of the present invention, a method for indicating driver behavior is disclosed, comprising, in combination, the steps of providing at least one housing coupled to a rear portion of a vehicle, providing at least one lateral-view mirror coupled to the at least one housing, the at least one lateral-view mirror dimensioned to allow a driver to view objects positioned lateral to a rear portion of the vehicle by looking at a reflection of the objects reflected from the at least one lateral-view mirror to one of a rear-view mirror and a side-view mirror to a driver, providing at least one indicator light coupled to an exterior surface of the at least one housing and facing towards a rear portion of the vehicle, the at least one indicator light integrated with a vehicle indicator light system in order to allow the indicator light to indicate at least one of a braking signal and a turning signal, and a driver indicating at least one of a braking signal and a turning signal on the at least one indicator light by at least one of applying brakes and activating a turn signal.

In accordance with still another embodiment of the present invention, a lateral-view mirror assembly for a vehicle is disclosed, comprising, in combination, at least one housing dimensioned to be coupled to at least one of a driver's side rear side portion of a vehicle and a passenger's side rear side portion of a vehicle, at least one lateral-view mirror, each the at least one lateral-view mirror coupled to the at least one housing, the mirror dimensioned to allow a driver to view objects positioned lateral to one of the driver's side of a rear portion of the vehicle and the passenger's side of a rear portion of the vehicle by looking at a reflection of the objects reflected from the lateral-view mirror to a vehicle side-view mirror to the driver, and at least one antenna coupled to an interior surface of the at least one housing, the at least one antenna being dimensioned to receive at least one data signal, the at least one antenna being dimensioned to transmit the at least one data signal to an electronic device coupled to the vehicle.

In accordance with yet another embodiment of the present invention, a method for viewing other vehicles while driving is disclosed, comprising, in combination, the steps of providing a lateral-view mirror assembly comprising at least one housing coupled to a rear portion of a vehicle and at least one lateral-view mirror coupled to the at least one housing, the at least one lateral-view mirror dimensioned to allow a driver to view at least one other vehicle positioned lateral to a rear portion of the vehicle by looking at a reflection of the at least one other vehicle reflected from the at least one lateral-view mirror to either a rear-view mirror or a side-view mirror to the driver; and looking at the reflection of the at least one other vehicle reflected from the at least one lateral-view mirror to the rear-view mirror or side-view mirror.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is a perspective view of one embodiment of the lateral-view mirror assembly of the present invention, showing a housing mounted on a center portion of a top surface of a rear portion of a vehicle and containing a first mirror and a second mirror positioned in a line of sight with a rear view mirror. The housing contains two indicator lights integrated with the indicator light system of the vehicle that are shown indicating a left turn signal.

FIG. 1A is a perspective view of the housing of the lateral-view mirror assembly of FIG. 1.

FIG. 2 is a top view of another embodiment of the housing of the lateral-view mirror assembly of FIG. 1, in which substantially the entire rear portion of the housing comprises an indicator light.

FIG. 3 is a perspective view of another embodiment of the lateral-view mirror assembly of the present invention, showing a first housing mounted on a passenger's side rear side portion of a vehicle and containing a first lateral-view mirror. Also shown is a second housing mounted on a driver's side rear side portion of a vehicle and containing a second lateral-view mirror. As shown, substantially the entire rear portion of the housing comprises an indicator light and is shown indicating a right turn signal.

FIG. 4 is a perspective view of another embodiment of the housing of the lateral-view mirror assembly of FIG. 3, in which a rear surface of the housing comprises multiple indicator lights.

FIG. 5 is a perspective view of another embodiment of the housing of the lateral-view mirror assembly of FIG. 3, in which a rear and top rear surface of the housing comprises an indicator light.

FIG. 6 is a perspective view of another embodiment of the lateral-view mirror assembly of the present invention, showing a housing mounted on a substantially center portion of a spoiler coupled to a top surface of a rear portion of a vehicle and containing a first mirror and a second mirror positioned in a line of sight with the rear-view mirror. As shown, substantially the entire rear portion of the housing comprises an indicator light.

FIG. 7 is a perspective view of another embodiment of the lateral-view mirror assembly of the present invention, showing a first housing mounted to the top surface of a spoiler proximate a passenger's side portion of the vehicle and containing a first lateral-view mirror positioned in a line of sight with a rear view mirror of the vehicle and a second housing mounted to the top surface of the spoiler proximate a driver's side portion of the vehicle and containing a second lateral-view mirror positioned in a line of sight with the rear-view mirror of the vehicle. As shown, substantially the entire rear portion of each housing comprises an indicator light.

FIG. 8 is a perspective view of another embodiment of the lateral-view mirror assembly of FIG. 7, showing the first housing coupled to a bottom surface of the spoiler proximate a passenger's side portion of the vehicle and the second housing coupled to the bottom surface of the spoiler proximate a driver's side portion of the vehicle.

FIG. 9 is a rear view of the lateral-view mirror assembly of FIG. 8.

FIG. 10 is a top view of the lateral-view mirror assembly of FIG. 7.

FIG. 11 is a top view of another embodiment of the lateral-view mirror assembly of the present invention, showing a first housing mounted on a top surface of a rear portion of a vehicle proximate a passenger's side portion of the vehicle and containing a first lateral-view mirror positioned in a line of sight with a rear-view mirror of a vehicle and a second housing mounted on a top surface of a rear portion of a vehicle proximate a driver's side portion of the vehicle and containing a second lateral-view mirror positioned in a line of sight with a rear-view mirror of a vehicle. Each housing comprises two indicator lights.

FIG. 12 is a perspective view of the housing of the lateral-view mirror assembly of FIG. 11.

FIG. 13 is perspective view of a remote control used to transmit an actuation signal in order to adjust the lateral-view mirrors in the preferred embodiment of the present invention.

FIG. 14 is a side cross-sectional view of the housing of the lateral-view mirror assembly of FIG. 11. The housing is shown as having an antenna and an actuator.

FIG. 15 is a perspective view of a vehicle using the lateral-view mirror assembly of FIG. 1 to view another vehicle while changing lanes.

FIG. 16 is a top view of a vehicle using the lateral-view mirror assembly of FIG. 1 to view two other vehicles while changing lanes.

FIG. 17 is a perspective view of an SUV using another embodiment of the lateral-view mirror assembly of the present invention to view another vehicle while changing lanes.

FIG. 18 is a top view of an SUV using the lateral-view mirror assembly of FIG. 17 to view two other vehicles while changing lanes.

### DETAILED DESCRIPTION OF THE PREFERRED EMBODIMENTS

Referring to FIGS. 1-18, a lateral-view mirror assembly, referred to generically as lateral-view mirror assembly 10, is disclosed. The lateral-view mirror assembly 10 comprises at least one housing 14, at least one lateral-view mirror 22 (see FIGS. 1-5, 7, 8, 10, 11, 13-15, and 17) coupled to the housing 14 and dimensioned to allow a driver 34 (see FIGS. 1, 11, 15, 16, and 18) to view objects (not shown) positioned lateral to the driver's side 46 (see FIGS. 1, 3, 6, 11, and 15-18) of a rear portion 36 (see FIGS. 1, 3, 6, 11, and 15-18) of the vehicle 12 (see FIGS. 1, 3, 6, 11, and 15-18) and lateral to the passenger's side 48 (see FIGS. 1, 3, 6, 11, and 15-18) of the rear portion 36 of the vehicle 12. The housing 14 preferably contains at least one indicator light 24 (see FIGS. 1-7, 9, and 12) coupled to an exterior surface 16 (see FIGS. 1A, 2, 4, 5, and 12-14) of the housing 14 and integrated with a vehicle's standard indicator light system (not shown) in order to allow the indicator light 24 to indicate at least one of a braking signal and a turning signal (see FIGS. 1 and 1A).

Referring to FIGS. 1-2 and 15-16, a first embodiment of the lateral-view mirror assembly 10, referred to hereinafter as lateral-view mirror assembly 10a, is shown. The lateral-view mirror assembly 10a comprises a housing 14 containing two lateral-view mirrors 22 (see FIGS. 1A and 2) mounted to a vehicle 12 (shown in FIG. 1). It should be understood that although the drawings disclose a car, the vehicle 12 could be any type of automobile, golf cart, boat, etc. As shown in FIG. 1, the housing 14 is coupled to a center portion 40 of a top surface 38 of a rear portion 36 of the vehicle 12. The housing 14 has a first lateral-view mirror 22 that is positioned in a line of sight with a rear-view mirror 30 (see FIG. 1) and is dimensioned to allow a driver 34 to view objects positioned lateral to the passenger's side 48 of the rear portion 36 of the vehicle 12 by looking at a reflection of objects reflected from the first lateral-view mirror 22 to the rear-view mirror 30 to the driver 34. The second lateral-view mirror 22 is also positioned in a line of sight with the rear-view mirror 30 and is dimensioned to allow the driver 34 to view objects positioned lateral to the driver's side 46 of the rear portion 36 of the vehicle 12 by looking at a reflection of objects reflected from the second lateral-view mirror 22 to the rear-view mirror 30 to the driver 34. The lateral-view mirror assembly 10a also comprises at least one indicator light 24 coupled to an exterior surface 16 (see FIGS. 1A and 2) of the housing 14. The indicator light 24 is integrated with a vehicle indicator light system in order to allow the indicator light 24 to indicate a braking signal and/or a turning signal (see FIG. 1A). FIG. 1A shows one embodiment of the housing 14, hereinafter referred to as housing 14a, wherein two indicator lights 24 are shown as substantially narrow and are positioned side-by-side. FIG. 2 shows an alternate embodiment of the housing 14, hereinafter referred to as housing 14b, wherein substantially the entire rear surface 18 of the housing 14b comprises an indicator light 24 to indicate a braking signal and/or a turning signal. While, in these embodiments, the housing 14a has two indicator lights 24 that are substantially narrow and positioned side-by-side and the housing 14b comprises an indicator light 24 that encompasses substantially the entire rear surface 18 of the housing 14b, it should be clearly understood that substantial benefit could be derived from an alternative configuration of the lateral-view mirror assembly 10a in which more than two indicator lights 24 are used, or in which one or more indicator lights 24 have a different configuration so long as the one or more indicator lights 24 are visible.

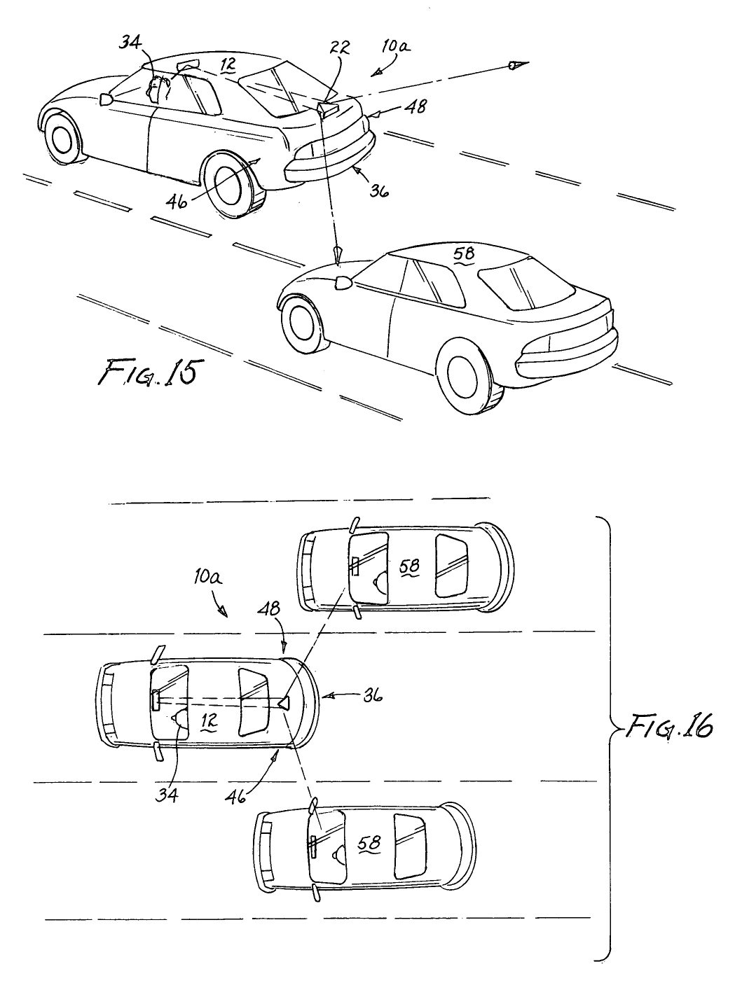

Referring now to FIGS. 3-5, a second embodiment of the lateral-view mirror assembly 10, referred to hereinafter as lateral-view mirror assembly 10b, is disclosed. The lateral-view mirror assembly 10b comprises a first housing 14 coupled to the passenger's side 48 of the rear portion 36 of the vehicle 12 and having a first lateral-view mirror 22 positioned in a line of sight with a passenger's side side-view mirror 32b (see FIG. 11). The first lateral-view mirror 22 is dimensioned to allow the driver 34 to view objects positioned lateral to the passenger's side 48 of the rear portion 36 of the vehicle 12 by looking at a reflection of the objects reflected from the first lateral-view mirror 22 to the passenger's side side-view mirror 32b to the driver 34. The lateral-view mirror assembly 10b also comprises a second housing 14 coupled to the driver's side 46 of the rear portion 36 of the vehicle 12 and having a second lateral-view mirror 22 positioned in a line of sight with the driver's side side-view mirror 32a (see FIG. 11). The second lateral-view mirror 22 is dimensioned to allow the driver 34 to view objects positioned lateral to the driver's side 46 of the rear portion 36 of the vehicle 12 by looking at a reflection of the objects reflected from the second lateral-view mirror 22 to the driver's side side-view mirror 32a to the driver 34. FIGS. 3 and 5 show another embodiment of the housing 14, hereinafter referred to as housing 14c wherein substantially the entire rear surface 18 of the housing 14c comprises an indicator light 24. FIG. 4 shows an alternate embodiment of the housing 14, hereinafter referred to as housing 14d, wherein two indicator lights 24 are shown as substantially narrow and are positioned horizontally. While, in these embodiments, the housing 14d has two indicator lights 24 that are substantially narrow and positioned horizontally and the housing 14c comprises an indicator light 24 that encompasses substantially the entire rear surface 18 of the housing 14c, it should be clearly understood that substantial benefit could be derived from an alternative configuration of the lateral-view mirror assembly 10b in which more than two indicator lights 24 are used, or in which one or more indicator lights 24 have a different configuration so long as the one or more indicator lights 24 are visible.

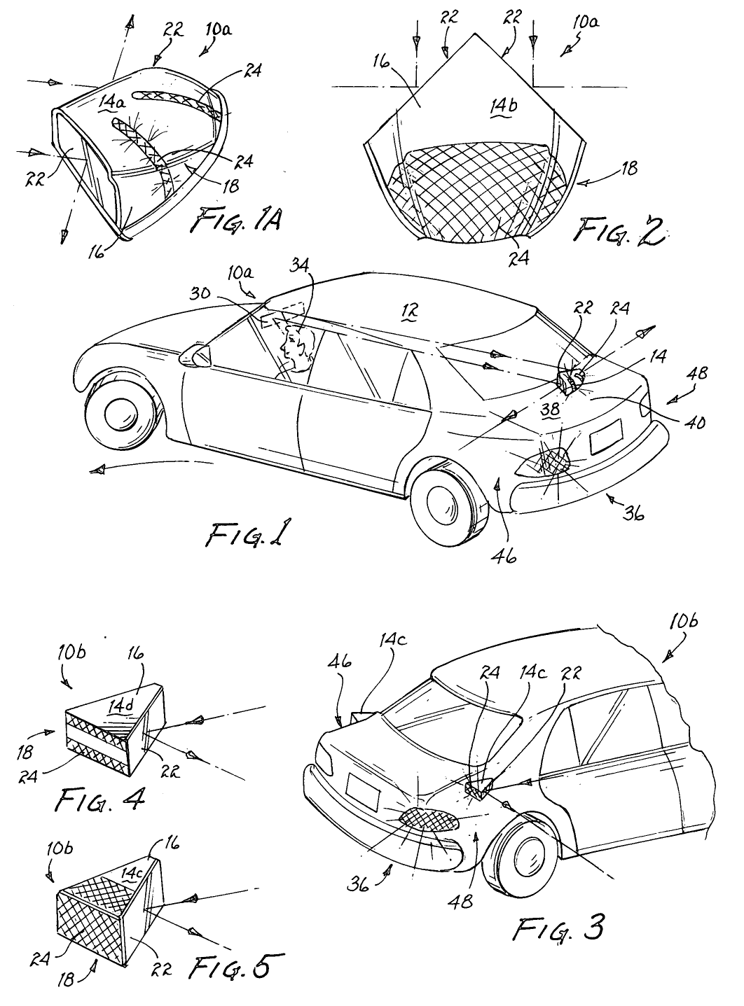

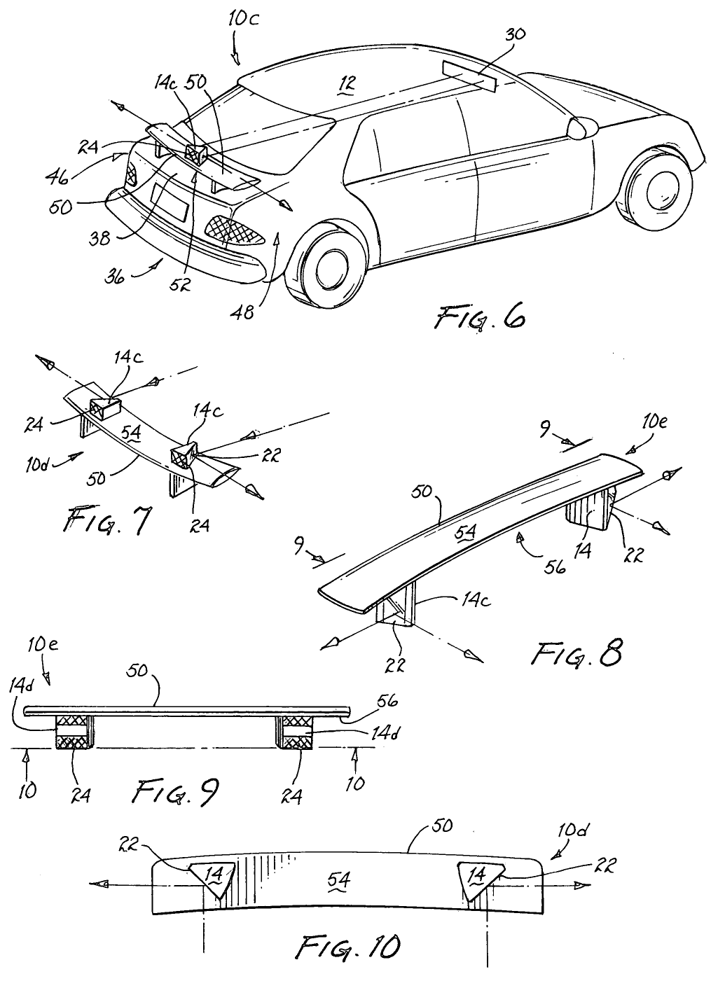

Referring now to FIG. 6, a third embodiment of the lateral-view mirror assembly 10, hereinafter referred to as lateral-view mirror assembly 10c, is shown. The lateral-view mirror assembly 10c is very similar to the lateral-view mirror assembly 10a, except that the housing 14 is coupled to a substantially center portion 52 of a spoiler 50 coupled to a top surface 38 of a rear portion 36 of the vehicle 12. As shown, substantially the entire rear portion of the housing 14c comprises an indicator light 24.

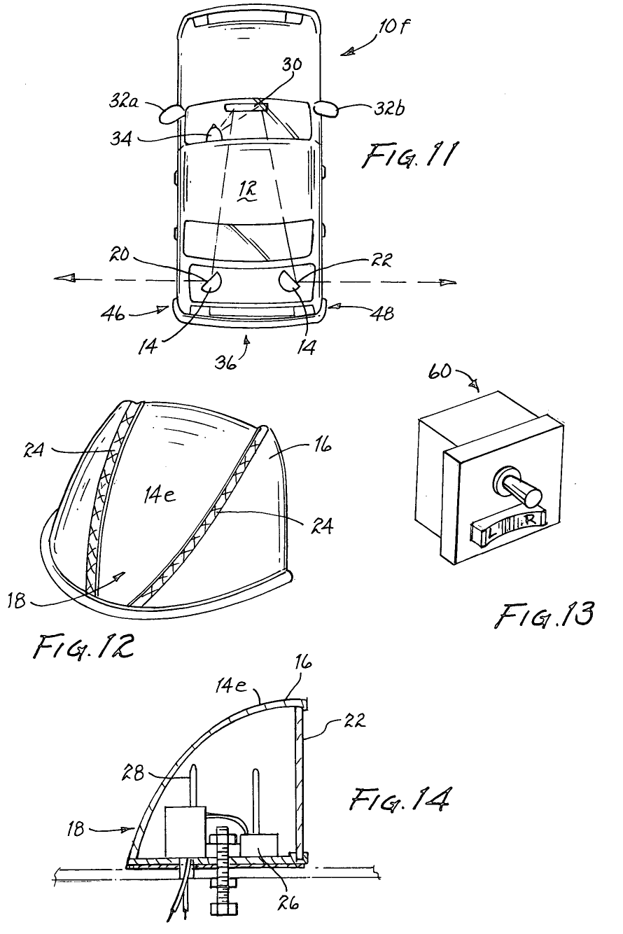

FIGS. 7 and 10 disclose a fourth embodiment of the lateral-view mirror assembly 10, hereinafter referred to as lateral-view mirror assembly 10d. In this embodiment of the lateral-view mirror assembly 10d, a first housing 14 is coupled to the top surface 54 of the spoiler 50 proximate a passenger's side 44 of the vehicle 12 and contains a first lateral-view mirror 22 positioned in a line of sight with the rear view mirror 30 of the vehicle 12. The first lateral-view mirror 22 is dimensioned to allow the driver 34 to view objects positioned lateral to the passenger's side 48 of the rear portion 36 of the vehicle 12 by looking at a reflection of the objects reflected from the first lateral view mirror 22 to the rear-view mirror 30 to the driver 34. A second housing 14 is mounted to the top surface 54 of the spoiler 50 proximate the driver's side 46 of the vehicle 12 and contains a second lateral-view mirror 22 positioned in a line of sight with the rear-view mirror 30 of the vehicle 12. The second lateral-view mirror 22 is dimensioned to allow the driver 34 to view objects positioned lateral to the driver's side 46 of the rear portion 36 of the vehicle 12 by looking at a reflection of the objects reflected from the second lateral-view mirror 22 to the rear-view mirror 30 to the driver 34. As shown in FIG. 7, substantially the entire rear portion of each housing 14c comprises an indicator light 24.

FIGS. 8-9 show a fifth embodiment of the lateral-view mirror assembly 10, hereinafter referred to as lateral-view mirror assembly 10e. The lateral-view mirror assembly 10e is essentially the same as the lateral-view mirror assembly 10d, except that the first housing 14 and the second housing 14 are coupled to a bottom surface 56 of the spoiler 50. Preferably, the first housing 14 and the second housing 14 form the support columns of the spoiler 50. FIG. 9 shows an embodiment of the housing 14d, wherein two indicator lights 24 are shown as substantially narrow and are positioned horizontally.

Referring now to FIGS. 11-13, a sixth embodiment of the lateral-view mirror assembly 10, hereinafter referred to as lateral-view mirror assembly 10f, is shown. The lateral-view mirror assembly 10f is similar to the lateral-view mirror assembly 10d, except that the first housing 14 and the second housing 14 are coupled to the top surface 38 of the rear portion 36 of a vehicle 12 having no spoiler 50. FIG. 12 shows another embodiment of the housing 14, hereinafter referred to as housing 14e, wherein two indicator lights 24 are shown as substantially narrow and are positioned side-by-side.

FIGS. 17 and 18 show a seventh embodiment of the lateral-view mirror assembly 10, hereinafter referred to as lateral-view mirror assembly 10g. The lateral-view mirror assembly 10g comprises a first housing 14 coupled to the driver's side 46 of the rear portion 36 of the vehicle 12 and a first lateral-view mirror 22 coupled to the first housing 14 and dimensioned to allow the driver 34 to view at least one other vehicle 58 positioned lateral to the passenger's side 48 of the rear portion 36 of the vehicle 12 by looking at a reflection of the at least one other vehicle 58 reflected from the first lateral-view mirror 22 to the rear-view mirror 30 to the driver 34. The lateral-view mirror assembly 10g also comprises a second housing 14 coupled to the passenger's side 48 of the rear portion 36 of the vehicle 12 and a second lateral-view mirror 22 coupled to the second housing 14 and dimensioned to allow the driver 34 to view the at least one other vehicle 58 positioned lateral to the driver's side 46 of the rear portion 36 of the vehicle 12 by looking at a reflection of the at least one other vehicle 58 reflected from the second lateral-view mirror 22 to the rear-view mirror 30 to the driver 34. Preferably, the lateral-view mirror assembly 10g will be used with a sport utility vehicle, a van, a minivan, or the like. However, it should be clearly understood that substantial benefit may be derived from using the lateral-view mirror assembly 10g with a sedan-type vehicle. The lateral-view mirror assembly 10 may therefore be used by a driver to spot another vehicle 58 that may be located in what would otherwise be the “blind spot” that exists when a vehicle 58 is located behind and lateral to a rear end of the vehicle 12 outside of a line of sight of both a rear-view mirror 30 and a side-view mirror 32. In this way, the lateral-view mirror assembly 10 can be used by a driver 34 while driving as an aid when changing lanes in order to identify other vehicles 58 that may otherwise have remained unseen.

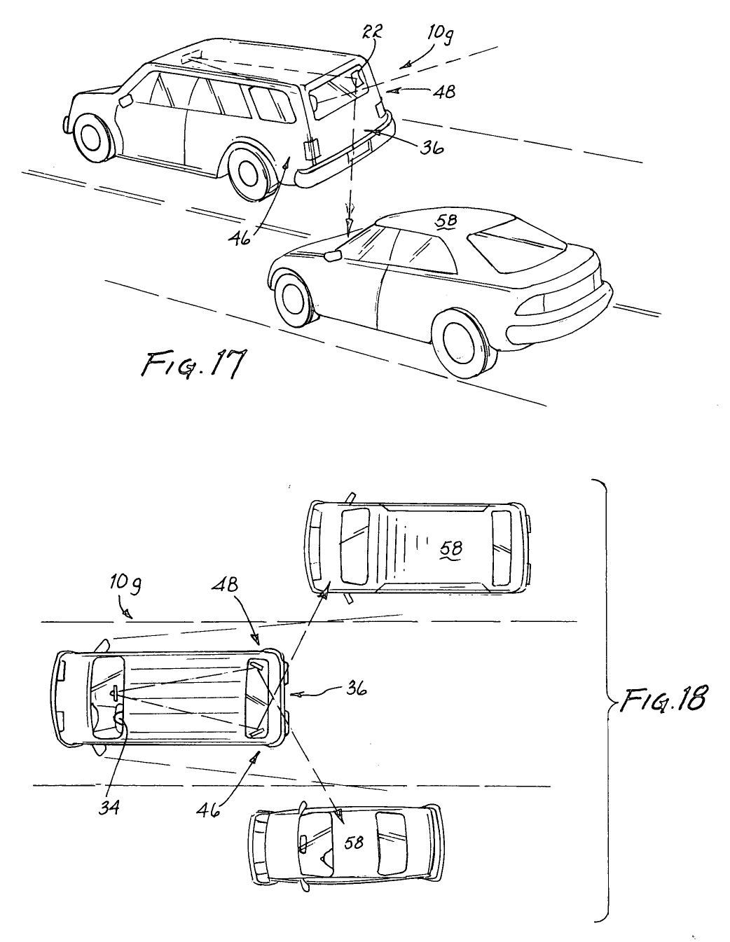

In the preferred embodiment of the lateral-view mirror assembly 10, each lateral-view mirror 22 will be equipped with a remote controlled system. The remote controlled system will comprise a remote control 60 (see FIG. 13) coupled to an interior portion of the vehicle 12 proximate a driver's side 46 of the vehicle 12 and an actuation device 26 (see FIG. 14). Preferably, the actuation device 26 is coupled to the housing 14 and is dimensioned to adjust the lateral-view mirror 22 relative to either a driver's side 46 or passenger's side 48 of the rear portion 36 of the vehicle 12 when a remote control 60 transmits an actuation signal to the actuation device 26. Further preferably, the remote control 60 comprises a pre-set position activator dimensioned to transmit a signal to the actuation device 26 to adjust the lateral-view mirror 22 to at least one pre-set position. For example, the lateral-view mirror 22 may automatically adjust to different positions, depending upon whether the driver 34 is backing out of a diagonal or straight parking space. And after backing out, the lateral-view mirror 22 may adjust to a normal driving position that will aid the driver 34 in viewing blind spots when the driver shifts the car into the “drive” position. As shown in FIGS. 15-18, the lateral-view mirrors 22 may also adjust when the driver 34 is changing lanes (FIGS. 15-16 show the lateral-view mirrors 22 in use with a sedan-type vehicle and FIGS. 17-18 show the lateral-view mirrors 22 in use with a sport utility vehicle). Although it is preferred that the lateral-view mirror assembly 10 have a remote controlled system, it should be clearly understood that substantial benefit may nevertheless be derived from a lateral-view mirror assembly 10 that is manually adjustable or simply fixed in one position.

It is also preferred that the lateral-view mirror assembly 10 comprise an antenna 28 (see FIG. 14) that is coupled to an interior surface 20 of the housing 14 and is dimensioned to receive at least one data signal. The antenna 28 will then transmit the data signal to an electronic device (not shown) coupled to the vehicle 12. Although it is preferred that the antenna 28 be able to receive at least one of an Internet signal, a GPS signal, a radio signal, a satellite signal, and a Doppler radar signal, it should be clearly understood that the antenna 28 may be capable of receiving any type of data signal.

While the invention has been particularly shown and described with reference to preferred embodiments thereof, it will be understood by those skilled in the art that the foregoing and other changes in form and details may be made therein without departing from the spirit and scope of the invention. For example, the lateral-view mirror 22 may be integrally coupled to the vehicle 12 during the manufacturing stage or, alternatively, coupled to the vehicle 12 after manufacture with an adhesive (not shown). While, it is preferred that the lateral-view mirror 22 be coupled to the vehicle 12 with an adhesive or integrally coupled to the vehicle 12 at the manufacturing stage, it should be understood that substantial benefit could be established through an alternative configuration of the lateral-view mirror assembly 10 in which a different kind of coupling mechanism is used so long as the lateral-view mirror 22 can be maintained in a position visible by the driver 34.

1. A lateral-view mirror assembly for a vehicle comprising, in combination:
at least one housing dimensioned to be coupled to at least one of a driver's side of a rear portion of a vehicle and a passenger's side of said rear portion of a said vehicle;
at least one lateral-view mirror, each said at least one lateral-view mirror coupled to said at least one housing, said lateral-view mirror dimensioned to allow a driver to view objects positioned lateral to one of said driver's side of a rear portion of said vehicle and said passenger's side of a rear portion of said vehicle by looking at a reflection of said objects reflected from said lateral-view mirror to a vehicle side-view mirror to said driver; and
at least one indicator light coupled to an exterior surface of said at least one housing, said at least one indicator light integrated with a vehicle indicator light system in order to allow said indicator light to indicate at least one of a braking signal and a turning signal.

2. The assembly of claim 1 wherein said lateral-view mirror is coupled to said driver's side of said rear portion of said vehicle during a manufacturing stage of said vehicle.

3. The assembly of claim 1 further comprising at least one side-view mirror coupled to a front side portion of a vehicle and dimensioned to allow a driver to view objects positioned behind and to a side of said vehicle, said at least one lateral-view mirror being positioned in a line of sight with said at least one side-view mirror so that a driver being capable of viewing objects positioned lateral to a rear portion of said vehicle by looking at a reflection of said objects reflected from said at least one lateral-view mirror to said at least one side-view mirror to said driver.

4. The assembly of claim 3 further comprising:
a first housing dimensioned to be coupled to said passenger's side of said rear portion of said vehicle;
a first lateral-view mirror coupled to said first housing, said first lateral-view mirror is positioned in a line of sight with a passenger's side side-view mirror, said first lateral-view mirror being dimensioned to allow a driver to view objects positioned lateral to said passenger's side of said rear portion of said vehicle by looking at a reflection of said objects reflected from said first lateral-view mirror to said passenger's side side-view mirror to said driver;
a second housing dimensioned to be coupled to said driver's side of said rear portion of said vehicle; and
a second lateral-view mirror coupled to said second housing, said second lateral-view mirror is positioned in a line of sight with a driver's side side-view mirror, said second lateral-view mirror being dimensioned to allow a driver to view objects positioned lateral to said driver's side of said rear portion of said vehicle by looking at a reflection of said objects reflected from said second lateral-view mirror to said driver's side side-view mirror to said driver.

5. The assembly of claim 1 wherein a first indicator light being coupled to a top surface of said housing and a second indicator light being coupled to a rear surface of said housing facing towards said rear portion of said vehicle.

6. The assembly of claim 1 wherein said housing having a substantially triangular shape.

7. The assembly of claim 1 further comprising a remote controlled system coupled to said vehicle and having:
a remote control coupled to an interior portion of said vehicle proximate said driver's side of said vehicle; and
at least one actuation device coupled to said at least one housing and dimensioned to adjust said at least one lateral-view mirror relative to a rear portion of said vehicle when said remote control transmits an actuation signal to said at least one actuation device.

8. The assembly of claim 1 further comprising at least one antenna coupled to an interior surface of said at least one housing, said at least one antenna being dimensioned to receive at least one data signal, said at least one antenna being dimensioned to transmit said at least one data signal to an electronic device coupled to said vehicle.

9. A lateral-view mirror assembly for a vehicle comprising, in combination:
a housing coupled to a substantially center portion of a top surface of a rear portion of a vehicle;
a first lateral-view mirror coupled to said housing, said first lateral-view mirror being positioned in a line of sight with a rear-view mirror of a vehicle, said first lateral-view mirror being dimensioned to allow a driver to view objects positioned lateral to a passenger's side of a rear portion of a vehicle by looking at a reflection of objects reflected from said first lateral-view mirror to a rear-view mirror to a driver;
a second lateral-view mirror coupled to said housing, said second lateral-view mirror being positioned in a line of sight with a rear-view mirror of a vehicle, said second lateral-view mirror being dimensioned to allow a driver to view objects positioned lateral to a driver's side of a rear portion of a vehicle by looking at a reflection of objects reflected from said second lateral-view mirror to a rear-view mirror to a driver;
at least one indicator light coupled to an exterior surface of said housing, said at least one indicator light integrated with a vehicle indicator light system in order to allow said indicator light to indicate at least one of a braking signal and a turning signal.

10. The assembly of claim 9 wherein said first lateral-view mirror and said second lateral-view mirror being flexibly coupled to said housing so that said first lateral-view mirror and said second lateral-view mirror being adjustable relative to said housing.

11. The assembly of claim 9 wherein said lateral-view mirror assembly being coupled to said rear center portion of said vehicle during a manufacturing stage of said vehicle.

12. The assembly of claim 9 further comprising a remote controlled system coupled to said vehicle and having:
a remote control coupled to an interior portion of said vehicle proximate a driver's side of said vehicle; and
at least one actuation device coupled to said housing and dimensioned to adjust at least one of said first lateral-view mirror and said second lateral-view mirror relative to said top surface of said vehicle when said remote control transmits an actuation signal to said at least one actuation device.

13. The assembly of claim 12 wherein said remote control comprises at least one pre-set position activator dimensioned to transmit a signal to said at least one actuation device to adjust said at least one of said first lateral-view mirror and said second lateral-view mirror to at least one pre-set position.

14. The assembly of claim 9 further comprising at least one antenna coupled to an interior surface of said housing, said at least one antenna being dimensioned to receive at least one signal from at least one of satellite radio, GPS navigation, AM radio and FM radio, said at least one antenna being dimensioned to transmit said at least one signal to an electronic device proximate a driver of said vehicle.

15. The assembly of claim 9 further comprising a rear-view mirror coupled to a front interior portion of a vehicle and positioned in a line of sight with said at least one lateral-view mirror so that a driver being able to view objects positioned lateral to a rear portion of said vehicle by looking at a reflection of said objects reflected from said at least one lateral-view mirror to said rear-view mirror to said driver.

16. The assembly of claim 9 wherein said housing being coupled to a substantially center portion of a spoiler coupled to a top surface of a rear portion of a vehicle.

17. The assembly of claim 9 wherein said first lateral-view mirror being dimensioned to allow a driver to view objects positioned in a blind spot by looking at a reflection of objects in said blind spot reflected from said first lateral-view mirror to a rear-view mirror to a driver.

18. The assembly of claim 9 wherein said at least one indicator light being coupled to a rear portion of said housing facing towards a rear end of said vehicle.

19. The assembly of claim 9 wherein a first indicator light being coupled to a rear portion of said housing facing towards a rear end of said vehicle and a second indicator light being coupled to a rear portion of said housing facing towards a rear end of said vehicle.

20. A lateral-view mirror assembly for a vehicle comprising, in combination:
a first housing dimensioned to be coupled to a top surface of a rear portion of a vehicle;
a first lateral-view mirror coupled to said first housing, said first lateral-view mirror being positioned in a line of sight with a rear-view mirror of a vehicle, said first lateral-view mirror being dimensioned to allow a driver to view objects positioned lateral to a passenger's side of a rear portion of a vehicle by looking at a reflection of objects reflected from said first lateral-view mirror to a rear-view mirror to a driver;
at least one indicator light coupled to an exterior surface of said first housing, said at least one indicator light integrated with a vehicle indicator light system in order to allow said indicator light to indicate at least one of a braking signal and a turning signal;
a second housing dimensioned to be coupled to a top surface of a rear portion of a vehicle;
a second lateral-view mirror coupled to said second housing, said second lateral-view mirror being positioned in a line of sight with a rear-view mirror of a vehicle, said second lateral-view mirror being dimensioned to allow a driver to view objects positioned lateral to a driver's side of a rear portion of a vehicle by looking at a reflection of objects reflected from said first lateral-view mirror to a rear-view mirror to a driver; and
at least one indicator light coupled to an exterior surface of said second housing, said at least one indicator light integrated with a vehicle indicator light system in order to allow said indicator light to indicate at least one of a braking signal and a turning signal.

21. The assembly of claim 20 wherein said first housing and said second housing are coupled to said top surface of said rear portion of said vehicle during a manufacturing stage of said vehicle.

22. The assembly of claim 20 wherein said first lateral-view mirror being flexibly coupled to said first housing and said second lateral-view mirror being flexibly coupled to said second housing so that said first lateral-view mirror being adjustable relative to said first housing and said second lateral-view mirror being adjustable relative to said second housing.

23. The assembly of claim 20 further comprising a remote controlled system coupled to said vehicle and having:
a remote control coupled to an interior portion of said vehicle proximate a driver's side of said vehicle; and
at least one actuation device coupled to said first housing and dimensioned to adjust said first lateral-view mirror relative to said top surface of said vehicle when said remote control transmits an actuation signal to said at least one actuation device of said first housing; and
at least one actuation device coupled to said second housing and dimensioned to adjust said second lateral-view mirror relative to said top surface of said vehicle when said remote control transmits an actuation signal to said at least one actuation device of said second housing.

24. The assembly of claim 23 wherein said remote control comprises at least one pre-set position activator dimensioned to transmit a signal to said at least one actuation device of said first housing to adjust said first lateral-view mirror to at least one pre-set position and said at least one pre-set position activator dimensioned to transmit a signal to said at least one actuation device of said second housing to adjust said second lateral-view mirror to at least one pre-set position.

25. The assembly of claim 20 further comprising at least one antenna coupled to an interior surface of at least one said first housing and said second housing, said at least one antenna being dimensioned to receive at least one data signal, said at least one antenna being dimensioned to transmit said at least one data signal to an electronic device coupled to said vehicle.

26. The assembly of claim 20 further comprising a rear-view mirror coupled to a front interior portion of a vehicle, wherein at least one of said first lateral-view mirror and said second lateral-view mirror being positioned in a line of sight with said rear-view mirror to allow a driver to view objects positioned lateral to a rear portion of a vehicle by looking at a reflection of objects reflected from at least one of said first lateral-view mirror and said second lateral-view mirror to said rear-view mirror to a driver.

27. The assembly of claim 20 wherein a first indicator light being coupled to a rear portion of said first housing facing towards a rear end of said vehicle and wherein a second indicator light being coupled to a rear portion of said first housing facing towards a rear end of said vehicle and wherein a third indicator light being coupled to a rear portion of said second housing facing towards a rear end of said vehicle and wherein a fourth indicator light being coupled to a rear portion of said second housing facing towards a rear end of said vehicle.

28. A lateral-view mirror assembly for a vehicle comprising, in combination:
a spoiler having a top surface and a bottom surface and coupled to a top area of a rear portion of a vehicle;
a first housing dimensioned to be attached to said spoiler proximate a passenger's side portion of said vehicle;
a first lateral-view mirror coupled to said first housing, said first lateral-view mirror being positioned in a line of sight with a rear view mirror of said vehicle, said first lateral-view mirror being dimensioned to allow a driver to view objects positioned lateral to a passenger's side of a rear portion of said vehicle by looking at a reflection of said objects reflected from said first lateral view mirror to said rear-view mirror to said driver;
at least one indicator light coupled to an exterior surface of said first housing, said at least one indicator light integrated with a vehicle indicator light system in order to allow said indicator light to indicate at least one of a braking signal and a turning signal;
a second housing dimensioned to be attached to said spoiler proximate a driver's side portion of said vehicle;
a second lateral-view mirror coupled to said second housing, said second lateral-view mirror being positioned in a line of sight with a rear-view mirror, said second lateral-view mirror being dimensioned to allow a driver to view objects positioned lateral to a driver's side of a rear portion of said vehicle by looking at a reflection of said objects reflected from said second lateral-view mirror to said rear-view mirror to said driver; and
at least one indicator light coupled to an exterior surface of said second housing and facing towards a rear portion of said vehicle, said at least one indicator light integrated with a vehicle indicator light system in order to allow said indicator light to indicate at least one of a braking signal and a turning signal.

29. The assembly of claim 28 wherein said first housing coupled to said top surface of said spoiler proximate a passenger's side portion of said vehicle and said second housing coupled to said top surface of said spoiler proximate a driver's side portion of said vehicle.

30. The assembly of claim 28 wherein said first housing coupled to said bottom surface of said spoiler proximate a passenger's side portion of said vehicle and said second housing coupled to said bottom surface of said spoiler proximate a driver's side portion of said vehicle.

31. The assembly of claim 28 wherein said first housing being integrated into a first vertical support of said spoiler and wherein said second housing being integrated into a second vertical support of said spoiler.

32. The assembly of claim 28 wherein said first housing and said second housing are coupled to said top surface of said rear portion of said vehicle during a manufacturing stage of said vehicle.

33. The assembly of claim 28 wherein said first lateral-view mirror being flexibly coupled to said first housing and said second lateral-view mirror being flexibly coupled to said second housing so that said first lateral-view mirror being adjustable relative to said first housing and said second lateral-view mirror being adjustable relative to said second housing.

34. The assembly of claim 28 further comprising a remote controlled system coupled to said vehicle and having:
a remote control coupled to an interior portion of said vehicle proximate a driver's side of said vehicle; and
at least one actuation device coupled to said first housing and dimensioned to adjust said first lateral-view mirror relative to said top surface of said vehicle when said remote control transmits an actuation signal to said at least one actuation device of said first housing; and
at least one actuation device coupled to said second housing and dimensioned to adjust said second lateral-view mirror relative to said top surface of said vehicle when said remote control transmits an actuation signal to said at least one actuation device of said second housing.

35. The assembly of claim 34 wherein said remote control comprises at least one pre-set position activator dimensioned to transmit a signal to said at least one actuation device of said first housing to adjust said first lateral-view mirror to at least one pre-set position and said at least one pre-set position activator dimensioned to transmit a signal to said at least one actuation device of said second housing to adjust said second lateral-view mirror to at least one pre-set position.

36. The assembly of claim 28 further comprising at least one antenna coupled to an interior surface of at least one said first housing and said second housing, said at least one antenna being dimensioned to receive at least one data signal, said at least one antenna being dimensioned to transmit said at least one data signal to an electronic device coupled to said vehicle.

37. The assembly of claim 28 further comprising a rear-view mirror coupled to a front interior portion of a vehicle, wherein at least one of said first lateral-view mirror and said second lateral-view mirror being positioned in a line of sight with said rear-view mirror to allow a driver to view objects positioned lateral to a rear portion of a vehicle by looking at a reflection of objects reflected from at least one of said first lateral-view mirror and said second lateral-view mirror to said rear-view mirror to a driver.

38. The assembly of claim 28 wherein said at least one indicator light being coupled to a rear portion of said first housing facing towards a rear end of said vehicle and wherein said at least one indicator light being coupled to a rear portion of said second housing facing towards a rear end of said vehicle.

39. A method for indicating driver behavior comprising, in combination, the steps of:
providing at least one housing coupled to a rear portion of a vehicle;
providing at least one lateral-view mirror coupled to said at least one housing, said at least one lateral-view mirror dimensioned to allow a driver to view objects positioned lateral to a rear portion of said vehicle by looking at a reflection of said objects reflected from said at least one lateral-view mirror to one of a rear-view mirror and a side-view mirror to a driver;
providing at least one indicator light coupled to an exterior surface of said at least one housing and facing towards a rear portion of said vehicle, said at least one indicator light integrated with a vehicle indicator light system in order to allow said indicator light to indicate at least one of a braking signal and a turning signal; and
a driver indicating at least one of a braking signal and a turning signal on said at least one indicator light by at least one of applying brakes and activating a turn signal.

40. The method of claim 39 further comprising the step of providing at least one antenna coupled to an interior surface of said at least one housing, said at least one antenna being dimensioned to receive at least one data signal, said at least one antenna being dimensioned to transmit said at least one data signal to an electronic device coupled to said vehicle.

41. The method of claim 40 wherein said data signal being at least one of an Internet signal, a GPS signal, a radio signal, a satellite signal, and a Doppler radar signal.

42. A lateral-view mirror assembly for a vehicle comprising, in combination:
at least one housing dimensioned to be coupled to at least one of a driver's side rear side portion of a vehicle and a passenger's side rear side portion of a vehicle;
at least one lateral-view mirror, each said at least one lateral-view mirror coupled to said at least one housing, said mirror dimensioned to allow a driver to view objects positioned lateral to one of said driver's side of a rear portion of said vehicle and said passenger's side of a rear portion of said vehicle by looking at a reflection of said objects reflected from said lateral-view mirror to a vehicle side-view mirror to said driver; and
at least one antenna coupled to an interior surface of said at least one housing, said at least one antenna being dimensioned to receive at least one data signal, said at least one antenna being dimensioned to transmit said at least one data signal to an electronic device coupled to said vehicle.

43. A method for viewing other vehicles while driving comprising the steps of:
providing a lateral-view mirror assembly comprising, in combination:
at least one housing coupled to a rear portion of a vehicle; and
at least one lateral-view mirror coupled to said at least one housing, said at least one lateral-view mirror dimensioned to allow a driver to view at least one other vehicle positioned lateral to a rear portion of said vehicle by looking at a reflection of said at least one other vehicle reflected from said at least one lateral-view mirror to one of a rear-view mirror and a side-view mirror to a driver;
looking at said reflection of said at least one other vehicle reflected from said at least one lateral-view mirror to said one of a rear-view mirror and a side-view mirror.

44. The method of claim 43 wherein said lateral-view mirror assembly comprising, in combination:
a housing coupled to a center portion of a top surface of a rear portion of a vehicle;
a first lateral-view mirror coupled to said housing, said first lateral-view mirror being positioned in a line of sight with said rear-view mirror of a vehicle, said first lateral-view mirror being dimensioned to allow said driver to view said at least one other vehicle positioned lateral to a passenger's side of said rear portion of said vehicle by looking at said reflection of said at least one other vehicle reflected from said first lateral-view mirror to said rear-view mirror to said driver;
a second lateral-view mirror coupled to said housing, said second lateral-view mirror being positioned in a line of sight with said rear-view mirror of a vehicle, said second lateral-view mirror being dimensioned to allow said driver to view said at least one other vehicle positioned lateral to a driver's side of said rear portion of said vehicle by looking at said reflection of said at least one other vehicle reflected from said second lateral-view mirror to said rear-view mirror to said driver;
at least one indicator light coupled to an exterior surface of said housing, said at least one indicator light integrated with a vehicle indicator light system in order to allow said indicator light to indicate at least one of a braking signal and a turning signal.

45. The method of claim 43 wherein said lateral-view mirror assembly comprising, in combination:
a first housing coupled to a driver's side of said rear portion of said vehicle;
a first lateral-view mirror coupled to said first housing and dimensioned to allow said driver to view said at least one other vehicle positioned lateral to a passenger's side of said rear portion of said vehicle by looking at a reflection of said at least one other vehicle reflected from said first lateral-view mirror to said rear-view mirror to said driver;
a second housing coupled to said passenger's side of said rear portion of said vehicle; and
a second lateral-view mirror coupled to said second housing and dimensioned to allow said driver to view said at least one other vehicle positioned lateral to said driver's side of said rear portion of said vehicle by looking at a reflection of said at least one other vehicle reflected from said second lateral-view mirror to said rear-view mirror to said driver.

46. The method of claim 45 wherein said vehicle being one of a sport utility vehicle, a van, and a minivan.
